(19) United States
(12) Patent Application Publication
(10) Pub. No.: US 2023/0281205 A1
(43) Pub. Date: Sep. 7, 2023

(54) Contextually Relevant Suggestions

(71) Applicant: Google LLC, Mountain View, CA (US)

(72) Inventor: Ramprasad Sedouram, Bengaluru (IN)

(73) Assignee: Google LLC, Mountain View, CA (US)

(21) Appl. No.: 17/653,123

(22) Filed: Mar. 1, 2022

(51) Int. Cl. G06F 16/2457; G06V 20/50; G06F 3/01; G06V 10/70; G06F 3/14; G06F 3/16

(52) U.S. Cl. CPC G06F 16/24575; G06F 3/017; G06F 3/14; G06F 3/167; G06V 10/768; G06V 20/50

(57) ABSTRACT

A method includes receiving a query requesting a digital assistant service to perform an action. The query includes a gesture-based query input by a user in response to the user performing a predetermined gesture detected by a gesture input device. The method also includes resolving a user intent of the query based on the predetermined gesture performed by the user, receiving a contextual signal associated with the user when the user performed the predetermined gesture, and generating a contextually-relevant response to the query based on the resolved user intent and the contextual signal.

### TECHNICAL FIELD

This disclosure relates to contextually relevant suggestions.

### BACKGROUND

A user may query a digital assistant executing on a computing device to obtain information and facts about a topic/entity or assist the user in accomplishing a certain task. In order to invoke the assistant through speech, the user is typically required to first speak a predetermined hotword (e.g., Ok Google. Alexa, etc.) before speaking a subsequence utterance that conveys the content of the query. Inherently, the user must be in range of a microphone of a user device executing the assistant and in in the absence of background noise in order for the predetermined hotword to be detected and the subsequence utterance of the query to be recognized. In the non-speech scenario, the user is required to access an application on a user device and enter a textual input conveying the contents of the query. These techniques are not easy to perform for users with busy hands and/or users who are on-the-go where they cannot hold the device to input a specific query or in a noisy environment.

### SUMMARY

One aspect of the disclosure provides a computer-implemented method for providing contextually relevant suggestions. The computer-implemented method when executed on data processing hardware causes the data processing hardware to perform operations that include receiving a query requesting a digital assistant service to perform an action. The query includes a gesture-based query input by a user in response to the user performing a predetermined gesture detected by a gesture input device. The operations also include resolving a user intent of the query based on the predetermined gesture 20 performed by the user, receiving a contextual signal associated with the user when the user performed the predetermined gesture, and generating a contextually-relevant response to the query based on the resolved user intent and the contextual signal.

Another aspect of the disclosure provides a system including data processing hardware and memory hardware in communication with the data processing hardware and storing instructions that when executed on the data processing hardware causes the data processing hardware to perform operations. The operations include receiving a query requesting a digital assistant service to perform an action. The query includes a gesture-based query input by a user in response to the user performing a predetermined gesture detected by a gesture input device. The operations also include resolving a user intent of the query based on the predetermined gesture 20 performed by the user, receiving a contextual signal associated with the user when the user performed the predetermined gesture, and generating a contextually-relevant response to the query based on the resolved user intent and the contextual signal.

The details of one or more implementations of the disclosure are set forth in the accompanying drawings and the description below. Other aspects, features, and advantages will be apparent from the description and drawings, and from the claims

### DESCRIPTION OF DRAWINGS

FIG. 1 is a schematic view of an example system for providing contextually relevant information to a user in response to recognizing a predetermined gesture performed by the user.

FIG. 2 is a flowchart of an example arrangement of operations for a method of delivering contextually relevant information in response to recognizing a predetermined gesture performed by the user.

FIG. 3 is a schematic view of an example computing device that may be used to implement the systems and methods described herein.

Like reference symbols in the various drawings indicate like elements.

### DETAILED DESCRIPTION

A user may query a digital assistant executing on a computing device to obtain information and facts about a topic/entity or assist the user in accomplishing a certain task. In order to invoke the assistant through speech, the user is typically required to first speak a predetermined hotword (e.g., Ok Google. Alexa, etc.) before speaking a subsequence utterance that conveys the content of the query. Inherently, the user must be in range of a microphone of a user device executing the assistant and in in the absence of background noise in order for the predetermined hotword to be detected and the subsequence utterance of the query to be recognized. In the non-speech scenario, the user is required to access an application on a user device and enter a textual input conveying the contents of the query. Additionally, the user will typically have to press a button to wake up the device in order to access the application and enter any textual inputs. These techniques are not easy to perform for users with busy hands and/or users who are on-the-go where they cannot hold the device to input a specific query or in a noisy environment.

The personal computing devices possessed by user’s today such as smart phones and wearables (e g., smart watch, smart headphones, etc.) have a built-in gesture recognition/detection capability that leverages various sensors/components of these devices For instances, these devices include accelerometers and/or gyrometers that can be leveraged to detect when a user performs a particular gesture. Radar sensors can also detect gestures. Additionally, graphical user interfaces executing on these devices may detect user input indications indicative of the user performing the particular gesture. For instance, the user may provide the user input indication via touch, mouse, or stylus. In additional implementations, user devices having image capture devices (e.g., camera) can be employed to capture image data and the user device can detect whether or not the captured image data includes the particular gesture performed by the user In lieu of a graphical user interface, a track pad employed by a user device may receive a user input indication indicative of the user performing the predetermined gesture.

Implementations herein are directed toward invoking a digital assistant service when a user performs a predetermined gesture detected by the gesture input device such that the predetermined gesture serves as a gesture-based query that requests information from the digital assistant service. Thereafter, the digital assistant service resolves a user intent of the query and generates a contextually-relevant response to the query based on the resolved user intent and a contextual signal associated with the user when the user performed the predetermined gesture. Notably, when the predetermined gesture performed by the user is detected by the gesture input device, the predetermined gesture serves the dual purpose as a trigger invoking the digital assistant service and a gesture-based query that requests information from the digital assistant service without requiring the user to provide any additional inputs (speech or typed) that specify the contents of the query or the information being requested from the digital assistant service In other words, based on the predetermined gesture performed by the user and the contextual signal, the digital assistant service is able to disambiguate the gesture-based query in order to generate a contextually-relevant response.

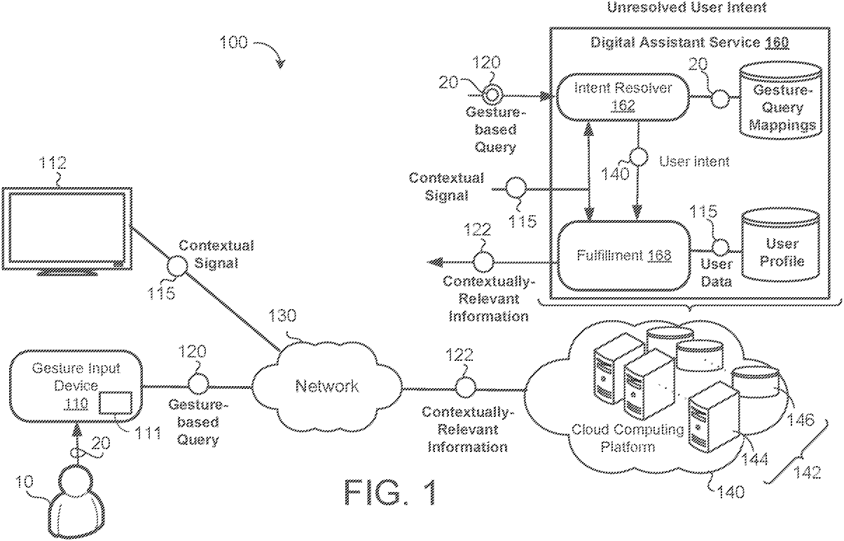

FIG. 1 is an example system 100 that includes a user device 110 associated with a user 10 that detects when the user 10 performs a predetermined gesture and communicates a gesture-based query 120 communicating queries 120 (e.g., also referred to as client content/data) over a network 130 to a distributed system (e.g., cloud computing platform) 140. The distributed system 140 may have scalable/elastic resources 142 (e.g, a storage abstraction) remote from local resources of the user device 110. The resources 142 include hardware resources 144 (e.g., data processing hardware), storage resources 146 (e.g, memory hardware), and/or software resources 148 (e.g., web-based applications or application programming interfaces (APIs)). The distributed system 140 executes a digital assistant service (DAS) 160 and the user 10 interfaces with the DAS 160 by performing gestures 20 input to, and detected by, the gesture input device 110 (e.g., using a digital assistant interface 114 or a web-browser application 116).

The gesture input device 110 can be any computing device or data processing hardware capable of communicating with the distributed system 140. Some examples of user devices 110 include, but are not limited to, desktop computing devices, mobile computing devices, such as laptops, tablets, smart phones, smart televisions, set-top boxes, smart speakers/displays, smart appliances, vehicle infotainment, and wearable computing devices (e.g., glasses, headsets, watches). The gesture input device 110 includes one or more sensors 111 capable of capturing data associated with user input indications indicative of the user 10 performing the predetermined gesture. These sensors 111 may physically reside on the device 10 and/or be separate from the device 110 but in communication therewith. The one or more sensors may include at least one of an accelerometer, a gyrometer, a graphical user interface, an image capture device, a trackpad, or a radar sensor.

The gesture input device 110 includes data processing hardware and memory hardware configured to communicate with the data processing hardware 111 to execute a process for detecting when data captured by one or more of the sensors is indicative of the predetermined gesture 20 performed by the user 10. When the predetermined gesture 20 is detected, the gesture input device 110 issues a corresponding gesture-based query 120 that invokes and requests the digital assistant service to perform an action. As used herein, the requested action for the DAS 160 to perform may include retrieving contextually-relevant information, retrieving contextually-relevant suggested content, and/or instructing another component/software to perform a task. That is, the gesture-based query 120 received by the DAS 160 may request the DAS 160 to obtain information and facts about a topic/entity and/or perform an action/operation

In some implementations, the user 10 consumes content (e.g., media content) output from a nearby device 112 such as a television, tablet, or computer. In some examples, the nearby device 112 and the gesture input device 110 are the same device. While consuming the content, the user 10 may issue the gesture-based query 120 directed toward the DAS 160 in order to request the DAS 160 to retrieve and provide suggested content and/or additional information related to the content the user 10 is consuming. For instance, the user 10 may be consuming content such as an episode of Master Chef where the chefs are preparing a coconut-based dessert, and when the predetermined gesture is performed by the user and detected by the gesture input device (e.g., a smart watch), the DAS 160 is invoked by a corresponding gesture-based query 120 to generate a contextually-relevant response 122 that may include information such as suggest similar recipes, a list of ingredients needed to prepare the dessert, and serve ads about restaurants that serve similar recipes.. The DAS 160 may provide the contextually-relevant response 122 as a graphical representation for output on a display of the nearby device 112 or another device. Additionally or alternatively, the DAS 160 may provide the contextually-relevant response 122 as an audio representation for output from a speaker in communication with the nearby device 112 or another device In another scenario, the user 10 may be using the nearby device 112 to access a web-based search engine and performance of the predetermined gesture 20 may invoke the search engine to provide contextually relevant suggestions such as an “I’m feeling lucky” suggestion that serves the user 10 with a most relevant search result for a search query.

The gesture-based query 120 received at the DAS 160 is ambiguous in that the query 120 does not specify what information is being requested or indicate a user intent. In other words, without more, the user intent of the gesture-based query 120 is unresolved. The DAS 160 may include a user intent resolver 162 that resolves the user intent 140 of the gesture-based query 120 based on the predetermined gesture 20 performed by the user 10. In some examples, the user intent resolver 162 accesses a data store 164 that stores associations between gestures and user intents and resolves the user intent 140 as the user intent that corresponds to the predetermined gesture 20. Here, the data store 164 may include a list of different gestures each paired with a corresponding user intent. The pairing between gestures and user intents may be preassigned by default Additionally or alternatively, some or all of the pairings may be customizable by the user 10 where the user can label a gesture with a specific user intent.

The predetermined gesture may mimic the shape of a company logo, a software application logo or first letter, or some other custom gesture provided by the user. For instance, the user 10 may perform a gesture during a registration process and then assign the custom gesture to a user intent. As used herein, the user intent may correspond at least one of a query type, an information source, a software application, or a particular action. For instance, the query type may indicate whether the user intent is for the DAS 160 to retrieve additional information related to a particular topic/entity, provide contextually-relevant suggestions, or perform a task.

The DAS 160 further includes a fulfillment stage 168 that receives the resolved user intent 140 and the contextual signal 115 as input, and generates, as output the contextually-relevant response 122. In some implementations, the contextual signal 115 received at the DAS 160 includes network-based information from a user account shared with the nearby device 112 in the environment of the user 10. Here, the network-based information may indicate content output by the nearby device 112. For instance, the content may include media content or informational content the user 10 is currently consuming. As such, the fulfillment stage 160 may generate the contextually-relevant response 122 that includes contextually-relevant information/suggestions related to the content being consumed by the user. As mentioned previously, the nearby device 112 and the gesture input device 110 may be the same device or different devices. The network-based information could include other types of information such as an indication that the nearby device 112 is receiving an incoming voice or video call, whereby the contextually-relevant response 122 generated by the fulfillment stage 160 may include the DAS 160 answering the incoming call or ignoring the incoming call by providing a preset message (e.g, “I’ll call you back”) to the caller. In this example, the nearby device 112 may include a smart phone or other computing device capable of receiving voice or video calls. The network-based information could also indicate the presence of an alarm/timer sounding, whereby the contextually-relevant response 122 includes the DAS 160 stopping the alarm. Advantageously, the user 10 need to only perform the predetermined gesture 20 to issue the gesture-based query 120 without the need of speaking or typing a query

In additional examples, the contextual signal 115 includes image data captured by an image capture device associated with the user, wherein the image data indicates content the user is likely consuming. For instance, the nearby device 112 may include a phone or smart glasses and the image capture device (e.g., camera) may reside on the phone or smart glasses. In a non-limiting example, the nearby device 112 includes smart glasses and the image data captured by the image capture device includes content conveyed on a page of a book the user 10 is currently reading Notably, the user may perform the predetermined gesture on the same page of the book such that the gesture input device 110 includes the image capture device capturing image data of the user performing the predetermined gesture. Continuing with the example, the image data may convey that the page in the book refers to a historic site in Greece, whereby the contextually-relevant response 122 generated by the DAS 160 includes suggested videos, images of the historic site, add suggestions about trips related to visiting the historic cite in Greece The contextually-relevant response 122, and information associated there with, may be presented as a graphical representation on a display screen of the smart glasses or some other connected device like a phone, television, or smart watch.

In some examples, the contextual signal 115 includes one or more user preferences obtained from a user account associated with the user. For instance, the fulfillment stage 168 may access a user profile explicitly input by the user and/or learned from historical behavior of the user 10. The contextual signal 115 can additionally or alternatively indicate at least one of a day, date, or time of day when the user performed the predetermined gesture 20. For instance, the user 10 could perform the gesture in complete darkness, and if it is the last day of the month, the contextually-relevant response 122 generated by the DAS 160 may include pending payments due for the month, tasks/to-do list for next month, or other things of interest to the user.

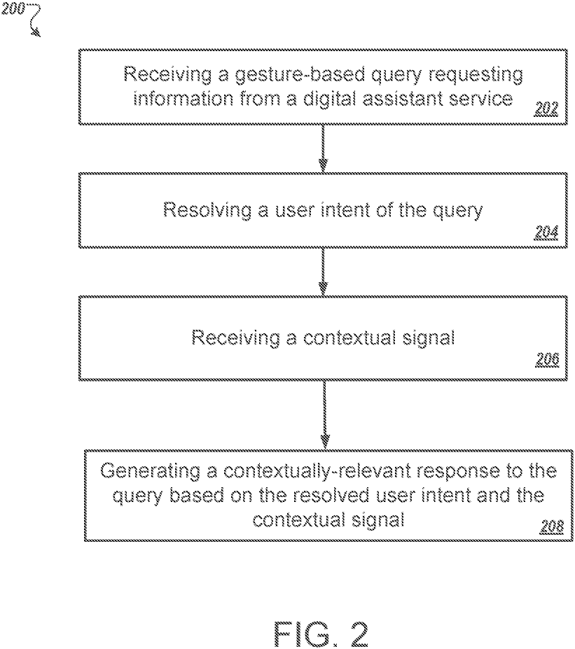

FIG. 2 is a flowchart of an example arrangement of operations for a method 200 of delivering contextually relevant information in response to recognizing a predetermined gesture performed by the user. At operation 202, the method 200 includes receiving a query 120 requesting a digital assistant service 160 to perform an action. The query 120 includes a gesture-based query input by a user 10 in response to the user performing a predetermined gesture 20 detected by a gesture input device 110.

At operation 204, the method includes resolving a user intent 140 of the query 120 based on the predetermined gesture 20 performed by the user. At operation 206, the method 200 also includes receiving a contextual signal 115 associated with the user when the user performed the predetermined gesture. At operation 208, the method includes generating a contextually-relevant response to the query based on the resolved user intent and the contextual signal 115.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g.. sequences of instructions) or data (e.g., program state information) on a temporary or permanent basis for use by a computing device The non-transitory memory may be volatile and/or non-volatile addressable semiconductor memory. Examples of non-volatile memory include, but are not limited to, flash memory and read-only memory (ROM) / programmable read-only memory (PROM) / erasable programmable read-only memory (EPROM) / electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

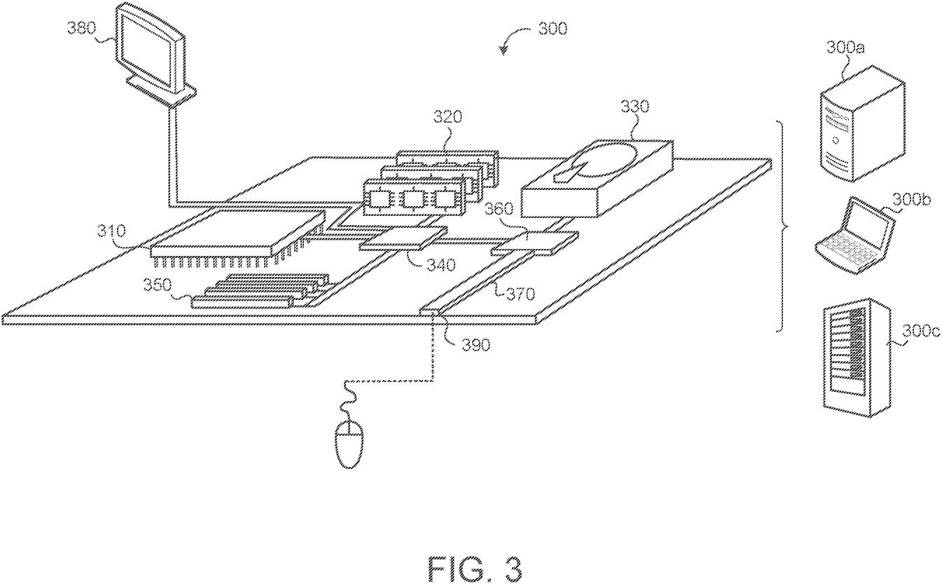

FIG. 3 is schematic view of an example computing device 300 that may be used to implement the systems and methods described in this document. The computing device 300 is intended to represent various forms of digital computers, such as laptops, desktops, workstations, personal digital assistants, servers, blade servers, mainframes, and other appropriate computers The components shown here, their connections and relationships, and their functions, are meant to be exemplary only, and are not meant to limit implementations of the inventions described and/or claimed in this document.

The computing device 300 includes a processor 310, memory 320, a storage device 330, a high-speed interface/controller 340 connecting to the memory 320 and high-speed expansion ports 350, and a low speed interface/controller 360 connecting to a low speed bus 370 and a storage device 330. Each of the components 310, 320, 330, 340, 350, and 360, are interconnected using various busses, and may be mounted on a common motherboard or in other manners as appropriate. The processor 310 can process instructions for execution within the computing device 300, including instructions stored in the memory 320 or on the storage device 330 to display graphical information for a graphical user interface (GUI) on an external input/output device, such as display 380 coupled to high speed interface 340. In other implementations, multiple processors and/or multiple buses may be used, as appropriate, along with multiple memories and types of memory. Also, multiple computing devices 300 may be connected, with each device providing portions of the necessary operations (e.g., as a server bank, a group of blade servers, or a multi-processor system).

The memory 320 stores information non-transitorily within the computing device 300. The memory 320 may be a computer-readable medium, a volatile memory unit(s), or non-volatile memory unit(s) The non-transitory memory 320 may be physical devices used to store programs (e.g., sequences of instructions) or data (e.g., program state information) on a temporary or permanent basis for use by the computing device 300. Examples of non-volatile memory include, but are not limited to, flash memory and read-only memory (ROM) / programmable read-only memory (PROM) / erasable programmable read-only memory (EPROM) / electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 330 is capable of providing mass storage for the computing device 300. In some implementations, the storage device 330 is a computer-readable medium. In various different implementations, the storage device 330 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier The computer program product contains instructions that, when executed, perform one or more methods, such as those described above The information carrier is a computer- or machine-readable medium, such as the memory 320, the storage device 330, or memory on processor 310.

The high speed controller 340 manages bandwidth-intensive operations for the computing device 300, while the low speed controller 360 manages lower bandwidth-intensive operations. Such allocation of duties is exemplary only. In some implementations, the high-speed controller 340 is coupled to the memory 320, the display 380 (e.g., through a graphics processor or accelerator), and to the high-speed expansion ports 350, which may accept various expansion cards (not shown). In some implementations, the low-speed controller 360 is coupled to the storage device 330 and a low-speed expansion port 390. The low-speed expansion port 390, which may include various communication ports (e.g., USB, Bluetooth. Ethernet, wireless Ethernet), may be coupled to one or more input/output devices, such as a keyboard, a pointing device, a scanner, or a networking device such as a switch or router, e.g.. through a network adapter.

The computing device 300 may be implemented in a number of different forms, as shown in the figure. For example, it may be implemented as a standard server 300a or multiple times in a group of such servers 300a, as a laptop computer 300b, or as part of a rack server system 300c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e g., EPROM, EEPROM, and flash memory devices; magnetic disks, e.g., internal hard disks or removable disks, magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g.. a mouse or a trackball, by which the user can provide input to the computer. Other kinds of devices can be used to provide interaction with a user as well; for example, feedback provided to the user can be any form of sensory feedback, e g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user’s client device in response to requests received from the web browser

A number of implementations have been described. Nevertheless, it will be understood that various modifications may be made without departing from the spirit and scope of the disclosure. Accordingly, other implementations are within the scope of the following claims.

What is claimed is:

1. A computer-implemented method that when executed on data processing hardware causes the data processing hardware to perform operations comprising:
receiving a query requesting a digital assistant service to perform an action, the query comprising a gesture-based query input by a user in response to the user performing a predetermined gesture detected by a gesture input device;
resolving a user intent of the query based on the predetermined gesture performed by the user;
receiving a contextual signal associated with the user when the user performed the predetermined gesture; and
generating a contextually-relevant response to the query based on the resolved user intent and the contextual signal.

2. The computer-implemented method of claim 1, wherein the gesture input device comprises:
a smart phone,
a wearable device;
a tablet;
a smart display/television;
a smart speaker;
a laptop/desktop computer,
an automobile infotainment system; or
a smart appliance.

3. The computer-implemented method of claim 1, wherein resolving the user intent of the query comprises:
accessing a data store that stores associations between gestures and user intents; and
resolving the user intent as the user intent that corresponds to the predetermined gesture.

4. The computer-implemented method of claim 1, wherein the contextual signal comprises network-based information from a user account shared with a nearby device in an environment of the user, the network-based information indicating content output by the nearby device.

5. The computer-implemented method of claim 4, wherein generating the contextually-relevant response comprises retrieving suggested content related to the content output by the nearby device.

6. The computer-implemented method of claim 1, wherein the contextual signal comprises image data captured by an image capture device associated with the user, the image data comprising content the user is likely consuming.

7. The computer-implemented method of claim 6, wherein generating the contextually-relevant response comprises retrieving suggested content related to the content output by the nearby device.

8. The computer-implemented method of claim 1, wherein the contextual signal comprises one or more user preferences obtained from a user account associated with the user.

9. The computer-implemented method of claim 1, wherein the contextual signal comprises at least one of a day, date, or time of day when the user performed the predetermined gesture.

10. The computer-implemented method of claim 1, wherein the operations further comprise providing a graphical representation of the contextually-relevant response for output from a user device associated with the user.

11. The computer-implemented method of claim 1, wherein the operations further comprise providing an audio representation of the contextually-relevant response for output from a user device associated with the user.

12. A system comprising:
data processing hardware, and
memory hardware in communication with the data processing hardware, the memory hardware storing instructions that when executed on the data processing hardware cause the data processing hardware to perform operations comprising:
receiving a query requesting a digital assistant service to perform an action, the query comprising a gesture-based query input by a user in response to the user performing a predetermined gesture detected by a gesture input device;
resolving a user intent of the query based on the predetermined gesture performed by the user;
receiving a contextual signal associated with the user when the user performed the predetermined gesture; and
generating a contextually-relevant response to the query based on the resolved user intent and the contextual signal.

13. The system of claim 12, wherein the gesture input device comprises:
a smart phone,
a wearable device;
a tablet;
a smart display/television;
a smart speaker,
a laptop/desktop computer,
an automobile infotainment system; or
a smart appliance.

14. The system of claim 12, wherein resolving the user intent of the query comprises:
accessing a data store that stores associations between gestures and user intents; and
resolving the user intent as the user intent that corresponds to the predetermined gesture.

15. The system of claim 12, wherein the contextual signal comprises network-based information from a user account shared with a nearby device in an environment of the user, the network-based information indicating content output by the nearby device.

16. The system of claim 15, wherein generating the contextually-relevant response comprises retrieving suggested content related to the content output by the nearby device.

17. The system of claim 12, wherein the contextual signal comprises image data captured by an image capture device associated with the user, the image data comprising content the user is likely consuming.

18. The system of claim 17, wherein generating the contextually-relevant response comprises retrieving suggested content related to the content output by the nearby device.

19. The system of claim 12, wherein the contextual signal comprises one or more user preferences obtained from a user account associated with the user.

20. The system of claim 12, wherein the contextual signal comprises at least one of a day, date, or time of day when the user performed the predetermined gesture.

21. The system of claim 12, wherein the operations further comprise providing a graphical representation of the contextually-relevant response for output from a user device associated with the user.

22. The system of claim 12, wherein the operations further comprise providing an audio representation of the contextually-relevant response for output from a user device associated with the user.
